(19) United States
(12) Patent Application Publication
(10) Pub. No.: US 2013/0216824 A1
(43) Pub. Date: Aug. 22, 2013

(54) TEAR-RESISTANT LAMINATE STRUCTURE

(71) Applicants: Michael P. Wade, Chesterfield, VA (US); Terrell J. Green, Raleigh, NC (US)

(72) Inventors: Michael P. Wade, Chesterfield, VA (US); Terrell J. Green, Raleigh, NC (US)

(21) Appl. No.: 13/400,919

(22) Filed: Feb. 21, 2012

(51) Int. Cl. B32B 3/00

(52) U.S. Cl. 428/332

(57) ABSTRACT

A laminate structure including a substrate, a single ply, oriented polyethylene film having a cross-sectional thickness ranging from about 1 to about 4 mils, and a tie layer positioned between the substrate and the polyethylene film, wherein the laminate structure has a machine direction and absorbs at least 1.5 inch-lbforce of energy before failing and stretches at least 15 percent before failing, as measured at any angle relative to the machine direction using the Graves tear test modified with an initial jaw separation of 2 inches.

### FIELD

This application relates to packaging materials and, more particularly, to paperboard-based laminate structures and, even more particularly, to tear-resistant paperboard-based laminate structures.

### BACKGROUND

A variety of consumer products are now typically packaged using tear-resistant packaging materials. As one example, large, over-sized containers formed from tear-resistant packaging materials are used to deter theft of relatively high price consumer products, such as electronics and fragrances. As another example, tear-resistant packaging materials are used to render pharmaceutical products, such as unit dose pharmaceuticals, child-resistant.

Unfortunately, a typical tear-resistant packaging material may become significantly more prone to tear propagation once an initiated tear point is formed in the packing material. While some packaging containers, such as clamshell containers, may be constructed without initiated tear points, other packaging containers, such as cartons and boxes, are formed from die-cut blanks that may inherently include initiated tear points. For example, a carton blank may include initiated tear points located where the major and minor end flaps connect to the body panels. Therefore, packaging containers formed with initiated tear points generally require packaging materials having a greater degree of tear-resistance.

Cost is a significant concern when manufacturing packaging materials. Each additional component or layer added to packaging material to improve tear-resistance also increases overall manufacturing costs. As manufacturing costs increase, so too does the final cost of the packaged product.

Accordingly, those skilled in the art continue with research and development efforts in the field of tear-resistant packaging materials.

### SUMMARY

In one aspect, the disclosed tear-resistant laminate structure may include a substrate, a single ply, oriented polyethylene film having a cross-sectional thickness ranging from about 1 to about 4 mils, and a tie layer positioned between the substrate and the polyethylene film, wherein the laminate structure has a machine direction and absorbs at least 1.5 inch-lbforce of energy before failing and stretches at least 15 percent before failing, as measured at any angle relative to the machine direction using the Graves tear test modified with an initial jaw separation of 2 inches.

In another aspect, the disclosed tear-resistant laminate structure may include a paperboard substrate, an oriented polyethylene film with the proviso that said film is not a cross-laminated film, and a tie layer positioned between the paperboard substrate and the polyethylene film, wherein the laminate structure has a machine direction and absorbs at least 1.5 inch-lbforce of energy before failing and stretches at least 15 percent before failing, as measured at any angle relative to the machine direction using the Graves tear test modified with an initial jaw separation of 2 inches.

In yet another aspect, disclosed is a method for forming a tear-resistant laminate structure. The method may include the steps of (1) providing a substrate, (2) providing a single ply, oriented polyethylene film having a cross-sectional thickness ranging from about 1 to about 4 mils, (3) melt extruding a tie layer material between said substrate and said film, and (4) pressing said substrate into engagement with said film (e.g., in a roller nip) to form the laminate structure.

Other aspects of the disclosed tear-resistant laminate structure and method will become apparent from the following detailed description, the accompanying drawings and the appended claims.

### BRIEF DESCRIPTION OF THE DRAWINGS

FIG. 1 is a schematic cross-sectional view of one aspect of the disclosed tear-resistant laminate structure;

FIG. 2 is a schematic flow diagram of one particular method for forming the tear-resistant laminate structure of FIG. 1;

FIG. 3 is a top plan view of a container blank formed from the tear-resistant laminate structure of FIG. 1;

FIG. 4 is an isometric view of a container assembled from the container blank of FIG. 3; and

FIG. 5 is a top plan view of a specimen being collected from the disclosed tear-resistant laminate structure for tear-resistance testing.

### DETAILED DESCRIPTION

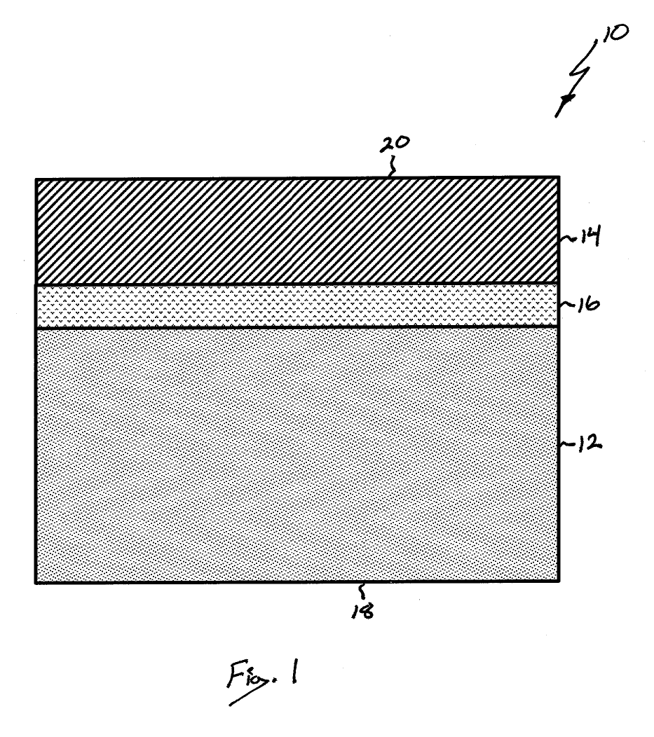

Referring to FIG. 1, one aspect of the disclosed tear-resistant laminate structure, generally designated 10, may include a substrate 12, a polyethylene film 14 and a tie layer 16 positioned between the substrate 12 and the polyethylene film 14. The laminate structure 10 may have a first major surface 18 defined by the substrate 12 and a second major surface 20 defined by the polyethylene film 14.

The substrate 12 may be a paperboard substrate. Examples of suitable paperboard substrates include, but are not limited to, solid bleached sulfate (SBS), coated brown board (CUK), corrugating medium, whiteboard and linerboard.

The substrate 12 may have an uncoated basis weight of at least 85 pounds per 3000 ft². For example, the substrate 12 may have a basis weight ranging from about 100 to about 200 pounds per 3000 ft².

The substrate 12 may have a cross-sectional thickness (caliper) of at least about 8 points. For example, the substrate 12 may have a cross-sectional thickness ranging from about 10 to about 28 points.

Optionally, the substrate 12 may be coated on at least one side to present a smooth, printable surface on the first major surface 18 of the laminate structure 10. Therefore, the first major surface 18 may be marked with various text and graphics, such as advertising text and graphics. Examples of suitable coatings include, but are not limited to, clay and calcium carbonate.

The tie layer 16 may be formed from or may include any material capable of adhering the polyethylene film 14 to the substrate 12. In one implementation, the tie layer 16 may be a layer of extruded polyolefin material, such as extruded polyethylene (e.g., low density polyethylene). In another implementation, the tie layer 16 may be an aqueous adhesive, such as a glue.

The cross-sectional thickness of the tie layer 16 may depend on, among other things, the type of material being used as the tie layer 16 and the amount of such material necessary to adhere the polyethylene film 14 to the substrate 12. For example, when the tie layer 16 is extruded low density polyethylene, the tie layer 16 may have a cross-sectional thickness of at least about 0.25 mils, such as about 0.5 mils, to ensure that the tie layer 16 is applied as a continuous (rather than discontinuous) layer.

The polyethylene film 14 may be a single-ply film of polyethylene having at least one major axis of orientation (i.e., a primary axis of orientation).

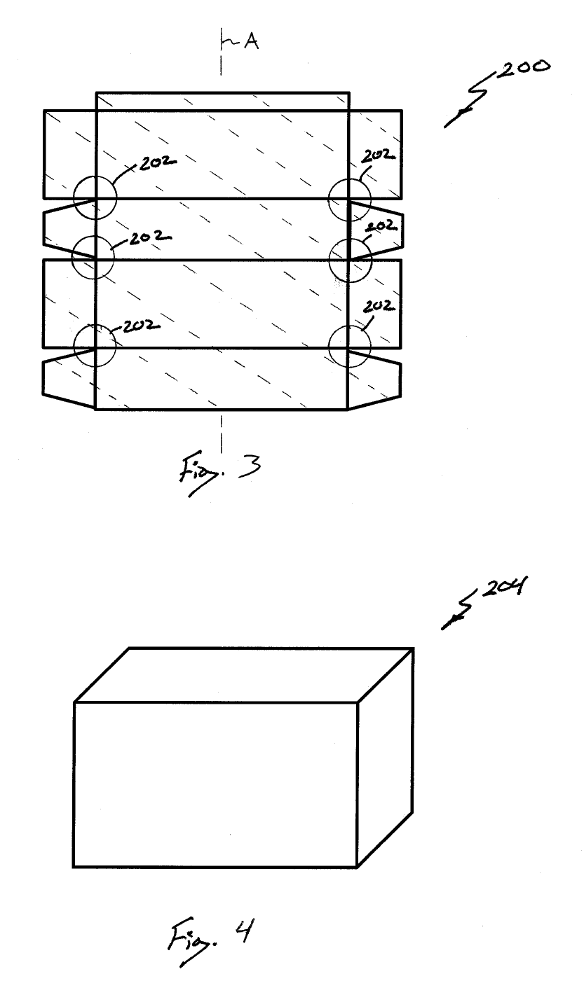

The primary axis of orientation of the polyethylene film 14 of the disclosed laminate structure 10 is shown with broken lines in FIG. 3. The primary axis of orientation of the polyethylene film 14 may be arranged at various angles (e.g., 0 degrees; 45 degrees) relative to the machine direction (axis A) of the laminate structure 10. Those skilled in the art will appreciate that the primary axis of orientation of the polyethylene film 14 relative to the machine direction (axis A) of the laminate structure 10 may depend on the manufacturing process used to make the polyethylene film 14.

The polyethylene film 14 may be formed from polyethylene, such as low density polyethylene, high density polyethylene and combinations thereof. In one particular construction, the polyethylene film 14 may be formed by co-extruding multiple layers of polyethylene. For example, the polyethylene film 14 may include a layer of high density polyethylene sandwiched between two layers of low density polyethylene. A polyethylene film 14 comprised of multiple co-extruded layers is still considered a single-ply film for the purposes of this disclosure.

The polyethylene film 14 may have a nominal cross-sectional thickness ranging from about 1 to about 4 mils. In one particular expression, the polyethylene film 14 may have a nominal cross-sectional thickness ranging from about 1.5 to about 2.5 mils. In another particular expression, the polyethylene film 14 may have a nominal cross-sectional thickness ranging from about 1.75 to about 2.25 mils. In yet another particular expression, the polyethylene film 14 may have a nominal cross-sectional thickness of about 2 mils.

It has been discovered that careful selection of the polyethylene film 14 may impart the laminate structure 10 with surprisingly high tear-resistance while maintaining material costs at a minimum. Without being limited to any particular theory, it is believed that the manufacturing process used to make the polyethylene film 14 may play a significant role in the tear-resistance of laminate structures 10 formed with the polyethylene film 14. Specifically, without being limited to any particular theory, it is believed that manufacturing processes that impart relatively little or no stretch to the film during processing preserve overall strength and stretch in the final film, while manufacturing processes that stretch the film relatively more during processing yield generally weaker films.

As one specific, but non-limiting example, the polyethylene film 14 may be a single layer of the polyethylene film used to manufacture the co-extruded, cross-laminated (i.e., double layer) polyethylene film sold under the IntePlus® brand by Inteplast Group, Inc. of Livingston, N.J. The IntePlus® brand co-extruded, cross-laminated film is described in greater detail in U.S. Patent Pub. No. 2009/0317650 published on Dec. 24, 2009, the entire contents of which are incorporated herein by references. A single layer of the polyethylene film used to manufacture the double-layer IntePlus® brand polyethylene film was obtained directly from Inteplast Group, Inc.

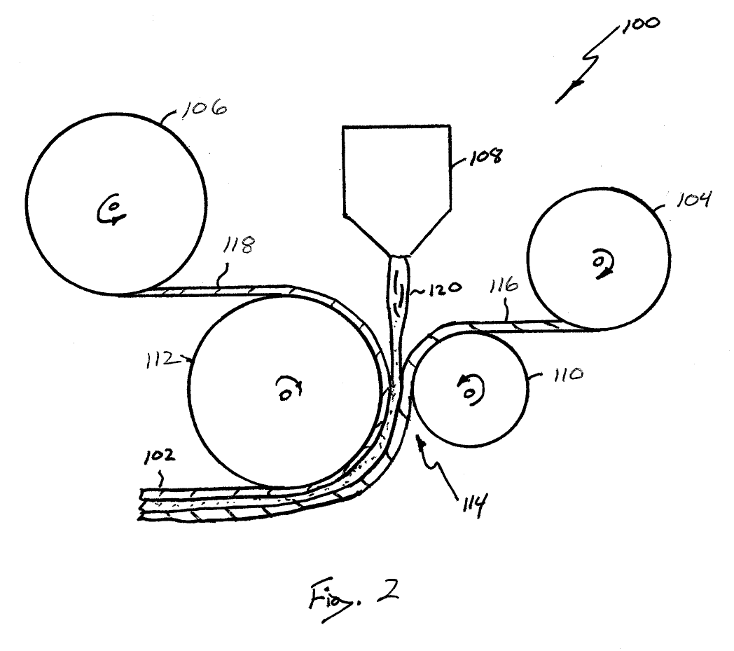

Referring to FIG. 2, also disclosed is a method, generally designated 100, for forming the disclosed tear-resistant laminate structure 102. The method 100 may be implemented with a roll of substrate 104, a roll of film 106, a melt extruder 108, and two rollers 110, 112 arranged to define a nip 114.

During manufacture, the substrate 116 may be unwound from the roll of substrate 104 onto the first roller 110 and the polyethylene film 118 may be unwound from the roll of film 106 onto the second roller 112. The extruder 108 may melt and extrude the tie-layer material 120 such that the tie-layer material is deposited between the substrate 116 and the polyethylene film 118. Then, the rollers 110, 112 may bring together the substrate 116 and the polyethylene film 118 proximate (i.e., at or near) the nip 114 such that the tie-layer material 120 adheres the polyethylene film 118 to the substrate 116, thereby forming the finished laminate structure 102.

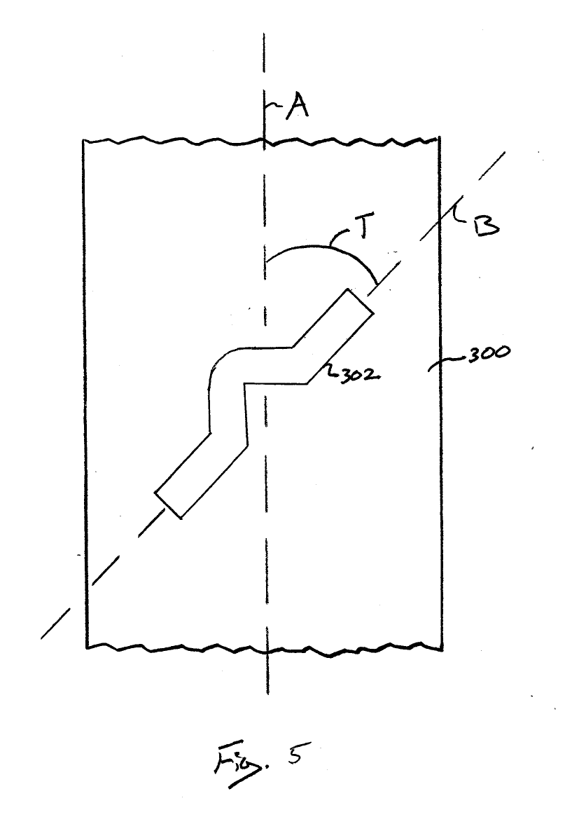

Referring to FIG. 3, the disclosed tear-resistant laminate structure may be die-cut to form a carton blank 200. The carton blank 200 may define one or more potential tear initiation points 202. Despite the presence of potential tear initiation points 202, the carton blank 200 may be assembled to form a tear-resistant carton 204, as shown in FIG. 4.

### EXAMPLES

### Example 1

A tear-resistant laminate structure was prepared having a paperboard substrate layer, an extruded tie layer and an oriented polyethylene film layer. The paperboard substrate was 16 point paperboard having a basis weight of 168 pounds per 3000 ft², sold under the PRINTKOTE® trademark by MeadWestvaco Corporation of Richmond, Va. The extruded tie layer was low density polyethylene applied at a weight of about 7 pounds per 3000 ft² to yield a tie layer having a nominal cross-sectional thickness of about 0.5 mils. The oriented polyethylene film layer was a single layer of the co-extruded, oriented polyethylene film used by Inteplast Group, Inc. to manufacture the cross-laminated (double layer) IntePlus® brand polyethylene film. The oriented polyethylene film layer had a nominal cross-sectional thickness of 2 mils and a nominal basis weight of 30 pounds per 3000 ft².

Referring to FIG. 5, the resulting sheet 300 of the tear-resistant laminate structure had a machine direction (axis A). Test specimens 302 were collected from the sheet 300 for tear resistance testing. The test specimens 302 had an axis B, and were collected from the sheet 300 at various angles T relative to the machine direction (axis A) to locate the weakest direction of the sheet 300. Initially, test specimens 302 were collected at angles T of 0 degrees, 45 degrees, 90 degrees and 135 degrees. Upon discovering that the initial test specimens 302 collected at an angle T of 135 degrees were the weakest, additional test specimens 302 were collected at angles T of 130 degrees and 140 degrees.

Tear resistance testing was performed on the test specimens 302 using an INSTRON® mechanical testing machine in accordance with the Graves tear test (ASTM D 1004-07), but with the modification that the initial jaw separation was 2 inches. The results of the tear resistance tests are presented in Table 1, and include the average percent elongation (i.e., the amount the test specimens 302 stretched before failure) and the average total energy absorbed (in inch-lbforce) by the test specimens 302 before failure.

TABLE 1

| | Elongation | Total Energy Absorbed |
|---|---|---|
| Angle | (%) | (inch-lbforce) |
| 0 | 105.27 | 5.80 |
| 45 | 64.35 | 4.98 |
| 90 | 102.11 | 5.34 |
| 130 | 31.31 | 2.37 |
| 135 | 31.78 | 2.45 |
| 140 | 38.69 | 2.86 |

As can be seen in Table 1, test specimens 302 formed from a single layer of the cross-laminated (double layer) IntePlus® brand film collected at an angle T of 130 degrees were the weakest, absorbing 2.37 inch-lbforce of energy and elongating 31.31 percent before failing.

### Example 2

### Comparative

For comparison, a laminate structure was prepared having a paperboard substrate layer, an extruded tie layer and an oriented polyethylene film layer. The paperboard substrate layer and the tie layer were the same as in Example 1. The oriented polyethylene film layer was a single layer of the film used by Valeron Strength Films of Houston, Tex. (an Illinois Tool Works, Inc. company) to manufacture their cross-laminated (double layer) polyethylene film sold under the VALERON® brand. The single layer VALERON® brand film was obtained directly from Valeron Strength Films, and had a nominal cross-sectional thickness of 1.75 mils.

The resulting sheet of the VALERON-based laminate structure was subjected to the same tear resistance testing used in Example 1, with initial test specimens collected at angles T of 0 degrees, 45 degrees, 90 degrees and 135 degrees. Upon discovering that the initial test specimens collected at an angle T of 45 degrees were the weakest, additional test specimens were collected at angles T of 40 degrees and 50 degrees.

The percent elongation and the total energy absorbed (in inch-lbforce) results for the laminate structure of Example 2 are presented in Table 2.

TABLE 2

| | Elongation | Total Energy Absorbed |
|---|---|---|
| Angle | (%) | (inch-lbforce) |
| 0 | 108.22 | 6.69 |
| 40 | 17.20 | 1.27 |
| 45 | 12.74 | 1.18 |
| 50 | 13.40 | 1.13 |
| 90 | 71.51 | 4.41 |
| 135 | 66.01 | 4.99 |

As can be seen in Table 2, test specimens formed from a single layer of the cross-laminated (double layer) VALERON® brand film collected at an angle T of 45 degrees were the weakest, absorbing only 1.18 inch-lbforce of energy and elongating only 12.74 percent before failing.

Thus, the laminate structure formed using a single layer of the cross-laminated (double layer) IntePlus® brand film (Example 1) was significantly stronger than the laminate structure formed using a single layer of the cross-laminated (double layer) VALERON® brand film (Example 2). Specifically, comparing the weakest direction (130 degrees) of the laminate structure of Example 1 to the weakest direction (45 degrees) of the laminate structure of Example 2, the laminate structure of Example 1 absorbed 2 times more energy and elongated almost 2.5 times as much as the laminate structure of Example 2.

At this point, those skilled in the art will appreciate that the total energy absorbed by a laminate structure will depend on the cross-sectional thickness of the oriented film used to form the laminate structure, but that the percent elongation of the laminate structure will have little or no dependence on the cross-sectional thickness of the oriented film. Therefore, while Example 1 uses an oriented film having a 2 mil nominal thickness and Example 2 uses an oriented film having a 1.75 mil nominal thickness, without being limited to any particular theory, it is believed that significantly better tear-resistance performance of the laminate structure of Example 1 is due to an overall better quality, stronger film rather than the slightly thicker (i.e., 0.25 mils) cross-sectional thickness of the film.

Thus, in a first expression, the disclosed tear-resistant laminate structure may be capable of absorbing at least 1.5 inch-lbforce of energy and may have a stretch (percent elongation) of at least 15 percent, as measured at any angle relative to the machine direction of the laminate structure using the Graves tear test (but with an initial jaw separation of 2 inches). In a first variation of the first expression, the disclosed tear-resistant laminate structure may be capable of absorbing at least 1.5 inch-lbforce of energy and may have a stretch of at least 20 percent, as measured at any angle relative to the machine direction of the laminate structure using the Graves tear test. In a second variation of the first expression, the disclosed tear-resistant laminate structure may be capable of absorbing at least 1.5 inch-lbforce of energy and may have a stretch of at least 25 percent, as measured at any angle relative to the machine direction of the laminate structure using the Graves tear test. In a third variation of the first expression, the disclosed tear-resistant laminate structure may be capable of absorbing at least 1.5 inch-lbforce of energy and may have a stretch of at least 30 percent, as measured at any angle relative to the machine direction of the laminate structure using the Graves tear test.

In a second expression, the disclosed tear-resistant laminate structure may be capable of absorbing at least 2 inch-lbforce of energy and may have a stretch of at least 15 percent, as measured at any angle relative to the machine direction of the laminate structure using the Graves tear test. In a first variation of the second expression, the disclosed tear-resistant laminate structure may be capable of absorbing at least 2 inch-lbforce of energy and may have a stretch of at least 20 percent, as measured at any angle relative to the machine direction of the laminate structure using the Graves tear test. In a second variation of the second expression, the disclosed tear-resistant laminate structure may be capable of absorbing at least 2 inch-lbforce of energy and may have a stretch of at least 25 percent, as measured at any angle relative to the machine direction of the laminate structure using the Graves tear test. In a third variation of the second expression, the disclosed tear-resistant laminate structure may be capable of absorbing at least 2 inch-lbforce of energy and may have a stretch of at least 30 percent, as measured at any angle relative to the machine direction of the laminate structure using the Graves tear test.

In a third expression, the disclosed tear-resistant laminate structure may be capable of absorbing at least 2.2 inch-lbforce of energy and may have a stretch of at least 15 percent, as measured at any angle relative to the machine direction of the laminate structure using the Graves tear test. In a first variation of the third expression, the disclosed tear-resistant laminate structure may be capable of absorbing at least 2.2 inch-lbforce of energy and may have a stretch of at least 20 percent, as measured at any angle relative to the machine direction of the laminate structure using the Graves tear test. In a second variation of the third expression, the disclosed tear-resistant laminate structure may be capable of absorbing at least 2.2 inch-lbforce of energy and may have a stretch of at least 25 percent, as measured at any angle relative to the machine direction of the laminate structure using the Graves tear test. In a third variation of the third expression, the disclosed tear-resistant laminate structure may be capable of absorbing at least 2.2 inch-lbforce of energy and may have a stretch of at least 30 percent, as measured at any angle relative to the machine direction of the laminate structure using the Graves tear test.

In a fourth expression, the disclosed tear-resistant laminate structure may be capable of absorbing at least 2.3 inch-lbforce of energy and may have a stretch of at least 15 percent, as measured at any angle relative to the machine direction of the laminate structure using the Graves tear test. In a first variation of the fourth expression, the disclosed tear-resistant laminate structure may be capable of absorbing at least 2.3 inch-lbforce of energy and may have a stretch of at least 20 percent, as measured at any angle relative to the machine direction of the laminate structure using the Graves tear test. In a second variation of the fourth expression, the disclosed tear-resistant laminate structure may be capable of absorbing at least 2.3 inch-lbforce of energy and may have a stretch of at least 25 percent, as measured at any angle relative to the machine direction of the laminate structure using the Graves tear test. In a third variation of the fourth expression, the disclosed tear-resistant laminate structure may be capable of absorbing at least 2.3 inch-lbforce of energy and may have a stretch of at least 30 percent, as measured at any angle relative to the machine direction of the laminate structure using the Graves tear test.

Accordingly, by careful selection of a single-ply, oriented polyethylene film layer, the disclosed tear-resistant laminate structure may exhibit relatively high tear-resistance without a significant increase in materials costs.

Although various aspects of the disclosed tear-resistant laminate structure have been shown and described, modifications may occur to those skilled in the art upon reading the specification. The present application includes such modifications and is limited only by the scope of the claims.

What is claimed is:

1. A laminate structure comprising:
a substrate;
a single ply, oriented polyethylene film having a cross-sectional thickness ranging from about 1 to about 4 mils; and
a tie layer positioned between said substrate and said polyethylene film,
wherein said laminate structure has a machine direction and absorbs at least 1.5 inch-lbforce of energy before failing and stretches at least 15 percent before failing, as measured at any angle relative to said machine direction using the Graves tear test (ASTM D 1004-07) modified with an initial jaw separation of 2 inches.

2. The laminate structure of claim 1 wherein said substrate comprises paperboard.

3. The laminate structure of claim 2 wherein said paperboard has a basis weight of at least 85 pounds per 3000 ft².

4. The laminate structure of claim 1 wherein said substrate comprises at least one coated surface.

5. The laminate structure of claim 1 wherein said tie layer comprises extruded polyethylene.

6. The laminate structure of claim 1 with the proviso that said polyethylene film is not a cross-laminated film.

7. The laminate structure of claim 1 wherein said cross-sectional thickness ranges from about 1.5 to about 2.5 mils.

8. The laminate structure of claim 1 wherein said cross-sectional thickness ranges from about 1.75 to about 2.25 mils.

9. The laminate structure of claim 1 wherein said polyethylene film comprises at least one of a low density polyethylene and a high density polyethylene.

10. The laminate structure of claim 1 wherein said polyethylene film comprises a plurality of co-extruded polyethylene layers.

11. The laminate structure of claim 1 wherein said laminate structure stretches at least 20 percent before failing.

12. The laminate structure of claim 1 wherein said laminate structure stretches at least 25 percent before failing.

13. The laminate structure of claim 1 wherein said laminate structure stretches at least 30 percent before failing.

14. The laminate structure of claim 1 wherein said laminate structure absorbs at least 2 inch-lbforce of energy before failing.

15. The laminate structure of claim 14 wherein said laminate structure stretches at least 25 percent before failing.

16. The laminate structure of claim 14 wherein said laminate structure stretches at least 30 percent before failing.

17. The laminate structure of claim 1 wherein said laminate structure absorbs at least 2.2 inch-lbforce of energy before failing.

18. A carton blank formed from the laminate structure of claim 1.

19. A carton formed from the carton blank of claim 18.

20. A laminate structure comprising:
a paperboard substrate;
a single ply, oriented polyethylene film having a cross-sectional thickness ranging from about 1.5 to about 2.5 mils, with the proviso that said film is not a cross-laminated film; and
a tie layer positioned between said substrate and said polyethylene film,
wherein said laminate structure has a machine direction and absorbs at least 2 inch-lbforce of energy before failing and stretches at least 20 percent before failing, as measured at any angle relative to said machine direction using the Graves tear test modified with an initial jaw separation of 2 inches.
